(19) United States
(12) Patent Application Publication
(10) Pub. No.: US 2026/0279051 A1
(43) Pub. Date: Sep. 17, 2026

(54) METHOD AND APPARATUS FOR VIDEO UNDERSTANDING, DEVICE AND PRODUCT

(71) Applicants: BYTEDANCE TECHNOLOGY LTD., Grand Cayman (KY); Tsinghua University, BEIJING (CN)

(72) Inventors: Changli TANG, Beijing (CN); Yixuan LI, Beijing (CN); Jimin ZHUANG, Beijing (CN); Yudong YANG, Beijing (CN); Guangzhi SUN, London (GB); Wei LI, Singapore (SG); Zejun MA, Singapore (SG); Chao ZHANG, Beijing (CN)

(21) Appl. No.: 19/566,955

(22) Filed: Mar. 13, 2026

(30) Foreign Application Priority Data
Mar. 14, 2025 (CN) 202510312187.7

(51) Int. Cl. G06V 20/40; G06V 10/77; G06V 10/776; G06V 20/70

(52) U.S. Cl. CPC G06V 20/42; G06V 10/7715; G06V 10/776; G06V 20/46; G06V 20/70

(57) ABSTRACT

The present disclosure relates to a method and apparatus for video understanding, a device and a product. The method comprises generating, by an image encoder, a plurality of image features based on a plurality of frames of a video. The method also comprises generating, by a multi-frame modality aligner, a visual token based on the plurality of image features, the visual token comprising a dynamic feature among the plurality of frames. Moreover, the method further comprises generating, by a language model, an understanding for the video based on the visual token.

### CROSS-REFERENCE TO RELATED APPLICATION(S)

This application claims priority to Chinese Application No. 202510312187.7 filed Mar. 14, 2025, the disclosure of which is incorporated herein by reference in its entirety.

### FIELD

The present disclosure relates to the field of computers, and more specifically, to method and apparatus for video understanding, device and product.

### BACKGROUND

Driven by the digital ages, video ecology has gone through developments and revolutions. Massive self-made short videos by the users flood into the social media platforms and film-television industry also puts forth many creative ideas, to provide an increased amount of high-definition, ultra high-definition and virtual reality videos. The video type has become more diversified and the broadcast range has been significantly expanded.

Meanwhile, deep learning technology has made significant progress. In video image feature extraction tasks, the convolutional neural network (CNN) is precise and efficient and can effectively identify various types of visual elements in the video. Recurrent neural network (RNN) and its variants, such as long short term memory (LSTM), excel in processing the complicated time sequence information of the video and can effectively analyze event sequence and dynamic changes in the video. Profited from expansion of video ecology and breakthroughs of the deep learning technology, the video content understanding technology steadily progresses and has been applied in many fields, such as intelligent security, video creation, education and healthcare etc. This brings new opportunities and transformations to the development of various industries.

### SUMMARY

In accordance with a first aspect of the present disclosure, there is provided a method for video understanding. The method comprises generating, by an image encoder, a plurality of image features based on a plurality of frames of a video. The method also comprises generating, by a multi-frame modality aligner, a visual token based on the plurality of image features, the visual token comprising a dynamic feature among the plurality of frames. Moreover, the method further comprises generating, by a language model, an understanding for the video based on the visual token.

In accordance with a second aspect of the present disclosure, there is provided an apparatus for video understanding. The apparatus comprises an image feature generating module configured to generate, by an image encoder, a plurality of image features based on a plurality of frames of a video. The apparatus also comprises a visual token generating module configured to generate, by a multi-frame modality aligner, a visual token based on the plurality of image features, the visual token comprising a dynamic feature among the plurality of frames. The apparatus further comprises an understanding generating module configured to generate, by a language model, an understanding for the video based on the visual token.

In accordance with a third aspect of the present disclosure, there is provided an electronic device, comprising a processor and a memory coupled to the processor, wherein the memory has instructions stored therein, the instructions, when being executed by the processor, causing the electronic device to execute the method according to the first aspect.

In accordance with a fourth aspect of the present disclosure, there is provided a computer program product. The computer program product is stored with computer-executable instructions thereon, wherein the computer-executable instructions, when executed by the processor, implement the method according to the first aspect.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Other features of the present disclosure will be understood more easily through the following description.

### BRIEF DESCRIPTION OF THE DRAWINGS

With reference to the drawings and the following detailed description, the above and other features, advantages and aspects of various embodiments of the present disclosure will become more apparent. In the drawings, same or similar reference signs indicate same or similar elements, wherein:

FIG. 1 illustrates a schematic diagram of an example environment in which a plurality of embodiments of the present disclosure may be implemented;

FIG. 2 illustrates a flowchart of a method for video understanding according to some embodiments of the present disclosure;

FIG. 3 illustrates a schematic diagram of an example overall structure of the visual understanding model in accordance with some embodiments of the present disclosure;

FIG. 4 illustrates a schematic diagram of an example structure of the multi-frame modality aligner in accordance with some embodiments of the present disclosure;

FIG. 5 illustrates a schematic diagram of an example effect for video understanding in accordance with some embodiments of the present disclosure;

FIG. 6 illustrates a schematic diagram of an example procedure for adjusting the multi-frame modality aligner and the language model in accordance with some embodiments of the present disclosure;

FIG. 7 illustrates a block diagram of an apparatus for video understanding in accordance with some embodiments of the present disclosure; and

FIG. 8 illustrates a block diagram of a device capable of implementing a plurality of embodiments of the present disclosure.

### DETAILED DESCRIPTION OF EMBODIMENTS

It is to be appreciated that all user-related data involved in the technical solution should be obtained and used after user authorization. This means that if the personal information of the users is to be used in the technical solution, explicit consent and authorization shall be given by the users before obtaining the personal information; otherwise, related data would not be collected and used. It also should be understood that in implementing the technical solution, one shall strictly follow relevant laws and regulations during collection, usage and storage of the data and take necessary techniques and measures to guarantee user data safety and ensure safe usage of data.

It is to be appreciated that prior to the use of the technical solutions disclosed by various embodiments of the present disclosure, type, usage scope and application scenario of personal information involved in the present disclosure are made known to users through suitable ways in accordance with the relevant laws and regulations, to obtain user authorization.

For example, in response to receiving an active request from the users, a prompt message is sent to the users to clearly inform them that the operation requested to be executed needs to obtain and use their personal information. Accordingly, the users may voluntarily select, in accordance with the prompt message, whether to provide their personal information to software or hardware that performs operations of the technical solution, such as electronic device, application program, server or storage medium.

As an optional and non-restrictive implementation, in response to receiving an active request from the users, a prompt message is sent to the users, wherein the prompt message may be present in the form of pop-up window as an example and the prompt message may be displayed in text in the pop-up window. Besides, the pop-up window also may be provided with a select control through which the users may choose to “agree” or “disagree” the provision of personal information to the electronic device.

It should be appreciated that the above procedure for informing the users and obtaining the user authorization is only exemplary and does not restrict the implementations of the present disclosure. Other methods may also be applied to the implementations of the present disclosure as long as they comply with relevant regulations and laws.

Embodiments of the present disclosure will be described below in more details with reference to the drawings. Although the drawings illustrate some embodiments of the present disclosure, it should be appreciated that the present disclosure can be implemented in various manners and should not be limited to the embodiments explained herein. On the contrary, the embodiments are provided for a more thorough and complete understanding of the present disclosure. It is to be understood that the drawings and the embodiments of the present disclosure are provided merely for the exemplary purpose, rather than restricting the protection scope of the present disclosure.

In the description of the embodiments of the present disclosure, the term “comprises” and its variants are to be read as open-ended terms that mean “comprises, but is not limited to.” The term “based on” is to be read as “based at least in part on.” The term “one embodiment” or “this embodiment” is to be read as “at least one embodiment.” The terms “first”, “second” and so on can refer to same or different objects. The following text also may include other explicit and implicit definitions.

As stated above, video content understanding techniques have developed steadily and have been applied in many fields. In the related art, to process the video data, the main practice is to sample a plurality of frames from the original video at a low frame rate and then analyze the discrete frames to obtain an understanding result of the video content. For example, the usual method comprises sampling at a rate of one frame per second (i.e., Frames Per Second, FPS=1) or uniformly extracting several frames from the entire video (e.g., uniformly extracting 8 frames). Such method is sufficient to capture the overall subject matter and the context of the video to some extent. However, the limitation of the method is obvious. Since the extracted information is limited in amount, the subsequent video content understanding techniques tend to overlook important video content information during dimension transformation and feature extraction. Especially in processing high-frame-rate videos, such as sports events or game live broadcast etc., it is harder for such method to capture key action details and rapid changes, which may lead to missing of vital information and further affect the analysis effects of the video content understanding.

For this, the present disclosure provides a method for video understanding to enhance the understanding of the video. According to embodiments of the present disclosure, a plurality of image features is generated by an image encoder based on a plurality of frames of a video. Then, the visual token is further generated, by means of a multi-frame modality aligner, according to the plurality of image features previously generated, the generated visual token comprising dynamic features among a plurality of frames. In the end, the generation of the result of the video content understanding is completed by a language model based on the generated visual token.

According to this method, this method boosts the accuracy of the video content understanding since the image features generated based on a plurality of frames of the video can capture abundant visual information of the video content. Next, the multi-frame modality aligner generates the visual token according to the generated image features, wherein the visual token integrates dynamic multi-frame information, to reduce the computation complexity of the subsequent language model while providing abundant visual information. Afterwards, the language model implements the understanding for the visual content of the video based on the generated visual token information. This method, combined with advantages of cross-modality fusion, enhances accuracy and comprehensiveness of the video content understanding in all aspects and further improves the user experience.

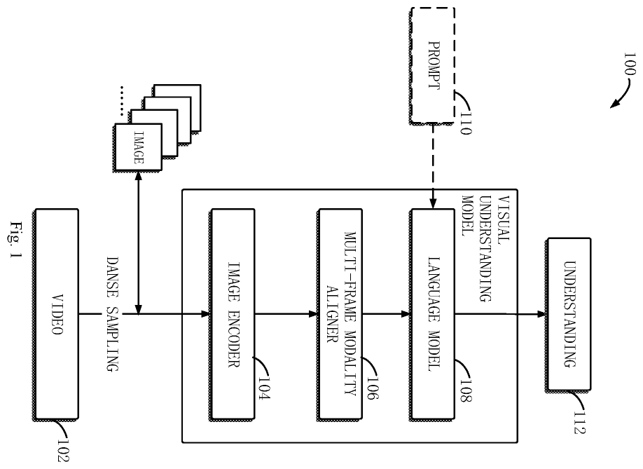

Embodiments of the present disclosure are to be described in detail below with reference to the drawings, wherein FIG. 1 illustrates a schematic diagram of an example environment 100 in which a plurality of embodiments according to the present disclosure may be implemented. As shown in FIG. 1, to understand the content of the video 102, a visual understanding model may be employed. The visual understanding model comprises an image encoder, a multi-frame modality aligner and a language model. In a video processing task, in order to more comprehensively and accurately capture abundant information contained in the video, the video 102 may be fine processed, i.e., frame pictures are extracted from a time sequence of the video 102 at a high frame rate (e.g., FPS=16). In other words, before the video 102 is fed into the visual understanding model, a plurality of images may be obtained by a dense sampling of pictures of video frames. If the sampling is performed at a frequency of FPS=16, 16 frames of images may be produced per second for the video 102. To facilitate the understanding, the following description is provided in a case where the length of the video 102 is 2 seconds and the sampling frame rate of the dense sampling is FPS=16. That is, 32 frames of images associated with the video 102 may be obtained after the dense sampling.

Referring to FIG. 1, after a large number of representative frames are obtained, these frame pictures (images) obtained from dense sampling are then collectively (e.g., in series connection) fed into the image encoder 104, to extract the information in these video frames, the information being presented in image feature form. In some embodiments, the image encoder may extract from the images representative image features that can reflect the content and structure of the images etc. Therefore, when the 32 frames of images are fed into the image encoder 104, the image encoder 104 may output 32 image features.

Continuing to refer to FIG. 1, after a plurality of image features are generated, the plurality of image features generated may be further fed into the multi-frame modality aligner 106 to produce a visual token. In some embodiments, the multi-frame modality aligner, as a visual text aligner, can map the image (or visual) information into a text space, so as to provide more valid inputs into the multi-modality task (e.g., visual question answering), thereby enhancing accuracy and reliability of the tasks. In some embodiments, these image features may first be concatenated and then fed into the multi-frame modality aligner 106, to generate the visual token. Accordingly, with respect to the above generated 32 image features, 16 frames of images in one second are adjacent to each other and are visually similar, so the adjacent 16 frames of images in one second may be concatenated. Therefore, two concatenated image features (each being concatenated from 16 image features) may be obtained. Afterwards, the two concatenated image features are fed into the multi-frame modality aligner 106 to generate two visual tokens. This is similar to obtaining two visual tokens from feeding two single-frame images. The difference is that the two visual tokens comprise multiple frames of dynamic visual information as the concatenated image features may be compressed mapped by the multi-frame modality aligner, which will be further explained in the following description.

As shown in FIG. 1, after the two visual tokens are obtained, an understanding 112 for the video content may be generated by means of the language model 108 and the related prompt 110 (if any). For example, the content of the video is an image regarding whether a basketball hits the basket or not and the prompt may be “please judge whether it is a hit”. In such case, the understanding for the video content may be “YES” or “NO”.

Through this method, the method boosts accuracy of the video content understanding since the image features generated based on a plurality of frames of the video can capture abundant visual information of the video content. Next, the visual token generated by the multi-frame modality aligner according to the generated image features can integrate multi-frame information and reduce the computation complexity of the subsequent language model while providing abundant visual information. Afterwards, the language model implements the understanding of the visual content of the video based on the generated visual token information. This method, combined with advantages of cross-modality fusion, enhances accuracy and comprehensiveness of the video content understanding in all aspects and further improves the user experience.

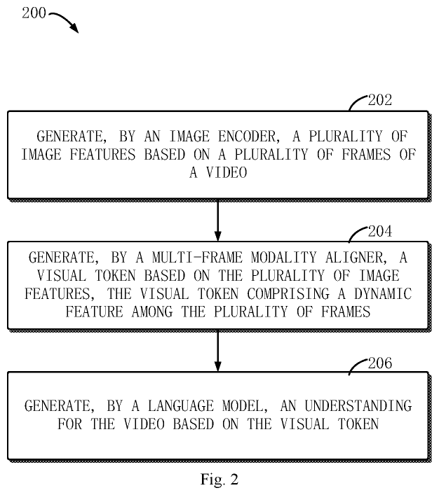

Next, the method according to embodiments of the present disclosure is described in detail below with reference to FIGS. 2-8. To facilitate the understanding, the specific data mentioned in the following description are exemplary and should not be used to define the protection scope of the present disclosure. It is to be appreciated that embodiments described below also may comprise additional acts not illustrated and/or omit the illustrated acts. The scope of the present disclosure is not restricted in this regard.

FIG. 2 illustrates a flowchart of a method 200 for video understanding according to some embodiments of the present disclosure. The method 200 may be executed by an apparatus for video understanding. The apparatus, for example, may be an independent apparatus or system. The apparatus may be implemented by software and/or hardware. Next, the method 200 is schematically explained using the apparatus for video understanding as the executive body. The method 200 comprises a block 202, a block 204 and a block 206.

As shown in FIG. 2, at block 202, the image encoder generates a plurality of image features based on a plurality of frames of the video. Referring to FIG. 1, after a large number of representative frames are obtained, these frame pictures (images) obtained from dense sampling are then collectively (e.g., in series connection) fed into the image encoder 104, to extract the information in these video frames, the information being presented in image feature form. In some embodiments, the image encoder may extract from the images representative image features that can reflect the content and structure of the images etc. Therefore, when the 32 frames of images are fed into the image encoder 104, the image encoder 104 may output 32 image features.

At block 204, the multi-frame modality aligner generates a visual token based on a plurality of image features, wherein the visual token comprises a dynamic feature among a plurality of frames. According to FIG. 1, after a plurality of image features are generated, the plurality of image features generated may be further fed into the multi-frame modality aligner 106 to produce a visual token, wherein the visual token comprises dynamic features among a plurality of frames. In other words, the visual token comprises abundant visual information. In some embodiments, the multi-frame modality aligner, as a visual text aligner, can map the image (or visual) information into a text space, so as to provide more valid inputs into the multi-modality task (e.g., visual question answering), thereby enhancing accuracy and reliability of the tasks.

At block 206, the language model generates the understanding for the video based on the visual token. As shown in FIG. 1, after the two visual tokens are obtained, an understanding 112 for the video content may be generated by means of the language model 108 and the related prompt 110 (if any). For example, the content of the video is an image regarding whether a basketball hits the basket or not and the prompt may be “please judge whether it is a hit”. In such case, the understanding of the video content may be “YES” or “NO”.

Through this method, the accuracy of the video content understanding can be boosted since the image features generated based on a plurality of frames of the video can capture abundant visual information of the video content. Next, the multi-frame modality aligner generates the visual token according to the generated image features, wherein the visual token integrates dynamic multi-frame information, to reduce the computation complexity of the subsequent language model while providing abundant visual information. Afterwards, the language model implements the understanding of the video content based on the generated visual token information. This method, combined with advantages of cross-modality fusion, enhances accuracy and comprehensiveness of the video content understanding in all aspects and further improves the user experience.

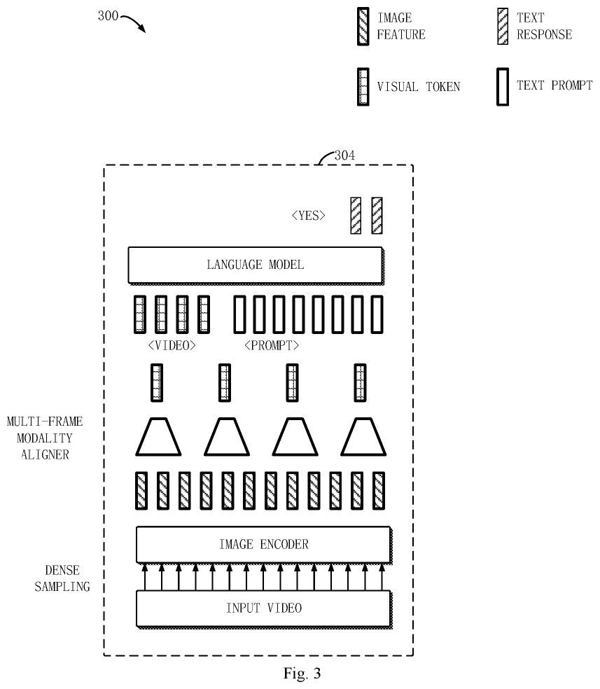

FIGS. 1 and 2 describe the example environment and method in which the embodiments of the present disclosure may be implemented and the method. Next, an example structure of the visual understanding model is depicted with reference to FIG. 3. FIG. 3 illustrates a schematic diagram of an example overall structure 300 of the video understanding model in accordance with some embodiments of the present disclosure. The example overall structure 300 shown in FIG. 3 may be the architecture of the visual understanding model shown in FIG. 1. According to FIG. 3, the visual understanding model takes video and text prompts as input and correspondingly generates a text response. For the input video, it is first densely sampled at a high frame rate (e.g., FPS=16) to extract a plurality of frames of images. The extracted frames of images are adjacent to each other and the adjacent frames of images are similar.

Continuing to refer to FIG. 3, next, a plurality of frames of images are encoded into an image space by the image encoder, to obtain a plurality of image features (assuming the image features are in D dimension) corresponding to the plurality of frames of images. For the sake of convenience and readability of the subsequent large language model processing, a plurality of image features corresponding to the plurality of frames of images that are adjacent and highly similar to each other may be compressed into the text space to obtain the visual token. To retain the visual information in the image features as much as possible, considering that linear transformation can better keep the semantic information extracted by the image encoder, the multi-frame modality aligner having linear layers may be employed to obtain the visual token which are compressed, yet still contain abundant visual information. In other words, the plurality of D-dimensional image features having abundant visual information may be fed into the multi-frame modality aligner to obtain the visual token. In some embodiments, the multi-frame modality aligner is a visual text aligner, so the visual token is a text-like feature suitable for large language model processing.

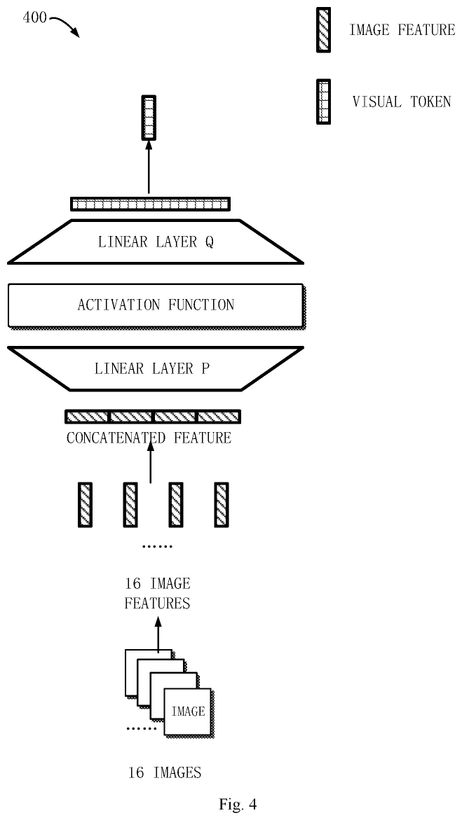

The example architecture of the multi-frame modality aligner is to be described below with reference to FIG. 4. FIG. 4 illustrates a schematic diagram of an example structure 400 of the multi-frame modality aligner in accordance with some embodiments of the present disclosure. According to FIG. 4, the example structure 400 of the multi-frame modality aligner consists of three layers of multilayer perceptions (MLP) comprising two linear layers and an activation function between the two linear layers. In some embodiments, the activation function may be GELU activation function.

As shown in FIG. 4, where the video duration is 1 second and FPS=16, i.e., 16 frames of images are sampled within one second, the 16 frames of images may then be output by the image encoder as 16 image features (the dimension of each image feature being D). Afterwards, before being input to the multi-frame modality aligner, the 16 image features may be concatenated along the feature dimension D, such that the multi-frame modality aligner may perform compressed transformation on the concatenated image features to generate visual token as the 16 frames of images within one second are adjacent to each other and are highly similar. In some embodiments, the image features may be concatenated by means of a local time window, wherein the window length of the local window may be w. To facilitate the understanding or the operation, w may be set to be the sampling frame rate FPS of 16. The local time window is calculated by the following formula:

$${Z}_{j}^{cat} = Concat ( {Z}_{j ω} , {Z}_{j ω + 1} , … , {Z}_{( j + 1 ) ω - 1} ) \qquad ( 1 )$$

Wherein

$${Z}_{j}^{cat}$$

is the concatenated image feature and: Z_{jw}, Z_{jw+1}, . . . , Z_{(j+1)w=-1} indicates w frame image features in the j-th window.

As shown in FIG. 4, the concatenated image feature (in dimension of W*D) may be mapped to a dimension of W*H (i.e., first dimension) from the W*D dimension via the linear layer P (i.e., first linear layer). Then, after passing through the activation function, the resulting image feature is mapped to a dimension of H (i.e., second dimension) from the dimension of W*H via the linear layer Q (i.e., second linear layer). In some embodiments, the concatenated image feature may be mapped to the dimension of W*H by the bias parameter and the weight parameter of the linear layer P. In some embodiments, the visual token output via the linear layer P, the activation function and the linear layer Q is indicated by the following formula:

$${\tilde{H}}_{j} = Q ( GELU ( P , {Z}_{j}^{cat} ) ) ) \qquad ( 2 )$$

Where H, is the visual token output by the multi-frame modality aligner; P and Q are parameters of the linear layers; GELU is the activation function;

$${Z}_{j}^{cat}$$

represents the concatenated image feature. In some embodiments, parameters of the linear layers may be bias parameter and weight parameter of the linear layers.

Continuing to refer to FIG. 4, after the multi-frame modality aligner outputs the visual token, in order to further compress the visual token, the generated token may be further pooled to obtain the pooled visual token, so as to reduce the quantity of the visual token. In some embodiments, the dimension size of the image features that are mapped to the dimension H (i.e., second dimension) may be adjusted first, and then the number of the visual token decreases through a 2D pooling layer. As shown in FIG. 4, an adjusted number of visual token may be obtained as output. The pooling formula is illustrated below:

$${H}_{j} = Max 2 DPool ( {\tilde{H}}_{j} ) \qquad ( 3 )$$

Where Hⱼ refers to the visual token whose number has been adjusted (i.e., the visual token available for input to the language model) and Max2DPool is the pooling function.

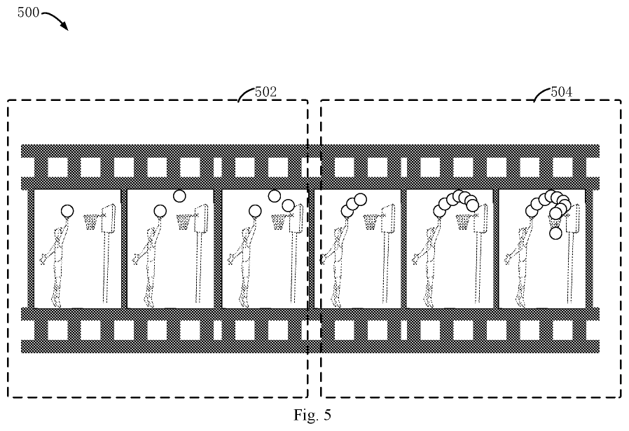

Returning to FIG. 3, after the visual token are obtained, the language model may generate the understanding for the video content in combination with the text prompt. FIG. 5 illustrates a schematic diagram of an example effect 500 for video understanding in accordance with some embodiments of the present disclosure. As shown, for example, the content of the video is an image regarding whether a basketball hits the basket or not and the prompt may be “please judge whether it is a hit”. The understanding for the video content generated by the language model may be “YES” or “NO”. As illustrated by area 504, the answer of the language model is “YES” according to the embodiments of the present disclosure. However, some other techniques which fail to obtain more high-frame visual information may answer “NO” in accordance with the picture of the image frame shown in area 502.

Through this method, abundant high-frame-rate visual information may be obtained to facilitate the language model to further understand the video content. At the same time, before the language model processes the visual information, the compression processing operation by the multi-frame modality aligner reduces the computation number of the language model. The method enhances accuracy and comprehensiveness of the video content understanding in all aspects, especially for the high-frame-rate videos, to further improve the user experience.

In some embodiments, a visual understanding model consisting of the language model, the multi-frame modality aligner and the image encoder may be trained. In some embodiments, loss of the visual understanding model may be determined according to the output of the language model, and the language model and the multi-frame modality aligner are adjusted by back propagation based on the loss, so as to converge the language model and the multi-frame modality aligner. The visual understanding model can be rapidly converged by such back propagation method.

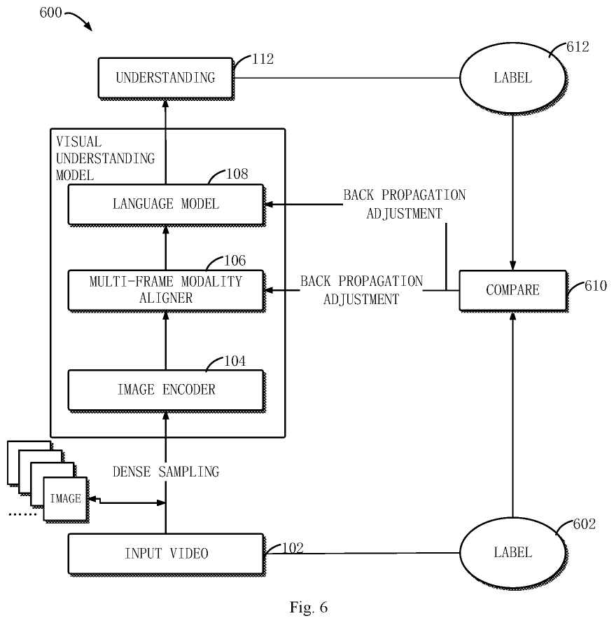

FIG. 6 illustrates a schematic diagram of an example procedure 600 for adjusting the multi-frame modality aligner and the language model in accordance with some embodiments of the present disclosure. Referring to FIG. 6, when the language model outputs a label 612, and the label of the input video is 602, the language model 108 and the multi-frame modality aligner 106 may be adjusted at 610 by comparing the video label 602 with the generated understanding label 612.

For the multi-frame modality aligner 106, in some embodiments, to save resources, the multi-frame modality aligner 106 may be initialized by means of the parameters of the pre-trained single-frame modality aligner. The single-frame modality aligner also comprises two linear layers and one activation function layer.

It is assumed that the linear layer A (i.e., third linear layer) of the single-frame modality aligner has a weight parameter W_{A} and a bias parameter b_{A}; and the linear layer B (i.e., fourth linear layer) of the single-frame modality aligner has a weight parameter W_{B} and a bias parameter b_{B}.

Accordingly, the weight parameter W_{P} and the bias parameter bp of the linear layer P and the weight parameter W_{Q} and the bias parameter b_{Q} of the linear layer Q of the multi-frame modality aligner in FIG. 4 may be initialized by the following formula. This is equivalent to averaging the values obtained after each frame of image passes through the single-frame modality aligner separately. In the following formula, w may be the sampling frame rate, i.e., w=FPS=16:

$${W}_{P} = ( \begin{matrix}{W}_{A} & O & ⋯ & O \\ O & {W}_{A} & ⋯ & O \\ ⋮ & ⋮ & ⋱ & ⋮ \\ O & O & ⋯ & {W}_{A}\end{matrix} ) \qquad ( 4 )$$

$${b}_{P} = ( \begin{matrix}{b}_{A} \\ {b}_{A} \\ ⋮ \\ {b}_{A}\end{matrix} ) , {W}_{Q} = \frac{1}{ω} ( \begin{matrix}{W}_{B} \\ {W}_{B} \\ ⋮ \\ {W}_{B}\end{matrix} ) , {b}_{Q} = {b}_{B} \qquad ( 5 )$$

It is to be appreciated that the bias parameter and the weight parameter of the multi-frame modality aligner 106 may also be adjusted through other ways. Such initialization method can save the computation resources and accelerate the training speed.

The adjustment of the multi-frame modality aligner indicates modifying the weight parameter and the bias parameter of the linear layer P and the linear layer Q in the multi-frame modality aligner. It is to be understood that the bias parameter is a bias matrix and the weight parameter is a weight matrix.

Returning to FIG. 4, after the weight parameter and the bias parameter of the linear layer P and the linear layer Q are determined, the formula (3) is expanded into the following formula to generate the visual token:

$$\begin{matrix}P ( {Z}_{j}^{cat} ) = ( \begin{matrix}{W}_{A} & O & ⋮ \\ O & ⋱ & O \\ ⋯ & O & {W}_{A}\end{matrix} ) ( \begin{matrix}{Z}_{j ω} \\ {Z}_{j ω + 1} \\ ⋮ \\ {Z}_{( j + 1 ) ω - 1}\end{matrix} ) + ( \begin{matrix}{b}_{A} \\ {b}_{A} \\ ⋮ \\ {b}_{A}\end{matrix} ) \\ = ( \begin{matrix}A ( {Z}_{j ω} ) \\ A ( {Z}_{j ω + 1} ) \\ ⋮ \\ A ( {Z}_{( j + 1 ) ω + 1} )\end{matrix} ) ,\end{matrix} \qquad ( 6 )$$

$$\begin{matrix}{\tilde{H}}_{j} = Q ( GELU ( P , {Z}_{j}^{cat} ) ) ) \\ = \frac{1}{ω} {( \begin{matrix}{W}_{B} \\ {W}_{B} \\ ⋮ \\ {W}_{B}\end{matrix} )}^{T} ( \begin{matrix}GELU ( A ( {Z}_{j ω} ) ) \\ GELU ( A ( {Z}_{j ω + 1} ) ) \\ ⋮ \\ GELU ( A ( {Z}_{( j + 1 ) ω + 1} ) )\end{matrix} ) + {b}_{B} \\ = \frac{1}{ω} {\sum }_{k = 0}^{ω - 1} B ( GELU ( A ( {Z}_{j ω + k} ) ) ) .\end{matrix} \qquad ( 7 )$$

Where w may be set to be the sampling frame rate of 16.

Through this method, abundant high-frame-rate visual information may be obtained to facilitate the language model to further understand the video content. At the same time, before the language model processes the visual information, the compression processing operation by the multi-frame modality aligner reduces the computation number of the language model. The method enhances accuracy and comprehensiveness of the video content understanding in all aspects, especially for the high-frame-rate videos, to further improve the user experience.

At the training phase of the visual understanding model, a high sampling frame rate is set to fully exploit the potential of the visual understanding model. However, to adapt to the actual application scenarios (e.g., non-sports low-frame-rate scenarios or low-frame-rate scenarios of games), a decoding strategy with variable frame rate may be adopted, to balance the computing resources and the operation efficiency. In some embodiments, at the FPS of 16 during training, if it is required to decrease the sampling frame rate during application, the frames sampled at the decreased sampling frame rate may be repeated properly to simulate a case in which 16 frames are sampled within one second. For example, during application, the frame is sampled at the FPS of 2, and each of the sampled frames may be repeated 8 times to simulate a case comprising 16 frames. Accordingly, the frames sampled at a lower than 16 frames per second can adapt to the output of the multi-frame modality aligner, thereby enhancing the application efficiency and improving the user experience. In other words, the user is allowed to adjust the frame rate for sampling the video frames during application, so as to improve real-time capability and practicability of the user applications within an acceptable range of performance loss.

According to this method, the accuracy of the video content understanding is boosted since the image features generated based on a plurality of frames of the video can capture abundant visual information of the video content. Next, the multi-frame modality aligner generates a visual token according to the generated image features, wherein the visual token integrates dynamic multi-frame information, to reduce the computation complexity of the subsequent language model while providing abundant visual information. Afterwards, the language model implements the understanding of the video content based on the generated visual token information. This method, combined with advantages of cross-modality fusion, enhances accuracy and comprehensiveness of the video content understanding in all aspects and further improves the user experience.

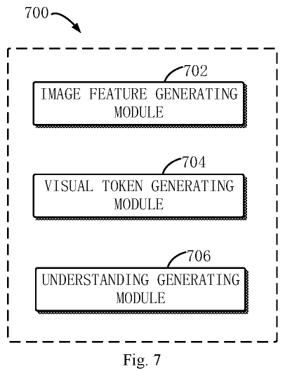

FIG. 7 illustrates a block diagram of an apparatus 700 for video understanding in accordance with some embodiments of the present disclosure. As shown in FIG. 7, the apparatus 700 comprises an image feature generating module 702 configured to generate, by an image encoder, a plurality of image features based on a plurality of frames of a video. The apparatus 700 also comprises a visual token generating module 704 configured to generate, by a multi-frame modality aligner, a visual token based on the plurality of image features, the visual token comprising a dynamic feature among the plurality of frames. Besides, the apparatus 700 further comprises an understanding generating module 706 configured to generate, by a language model, an understanding for the video based on the visual token.

In some embodiments, wherein the visual token generating module 704 comprises: a module for generating concatenated image feature configured to generate concatenated image features based on the plurality of image features; and a first generating module configured to generate, by the multi-frame modality aligner, the visual token based on the concatenated image features generated.

In some embodiments, the multi-frame modality aligner comprises a first linear layer and a second linear layer, and the first generating module comprises: a first mapping module configured to map, by the first linear layer, the concatenated image features to a first dimension based on a bias parameter and a weight parameter of the first linear layer; and a second mapping module configured to map, by the second linear layer, the concatenated image features mapped to the first dimension to a second dimension based on a bias parameter and a weight parameter of the second linear layer, the second dimension corresponding to an input dimension of the language model; and a second generating module is configured to generate the visual token based on the concatenated image features that are mapped to a second dimension.

In some embodiments, wherein the second generating module comprises: a first adjusting module configured to adjust a dimension size of the concatenated image features that are mapped to a second dimension; and an executing module configured to execute a feature pooling operation on the concatenated image features that are mapped to a second dimension with adjusted dimension size, to generate the visual token whose number has been adjusted.

In some embodiments, wherein the understanding generating module 706 comprises: a third generating module configured to generate, by the language model, an understanding for the video based on the visual token whose number has been adjusted and a prompt.

In some embodiments, the apparatus 700 also comprises: a training module configured to train a visual understanding model consisting of the image encoder, the multi-frame modality aligner and the language model.

In some embodiments, wherein the training module comprises: a first determining module configured to determine a loss of the visual understanding model based on an output of the language model; and a second adjusting module configured to adjust the language model and the multi-frame modality aligner through back propagation based on the loss.

In some embodiments, an understanding generated by the language model is a label, wherein the second adjusting module comprises: a third adjusting module configured to adjust the weight parameters and the bias parameters of the first linear layer and the second linear layer based on a label of the understanding generated by the language model and a label of the video.

In some embodiments, the apparatus 700 also comprises: an initialization module configured to initialize the weight parameters and the bias parameters of the first linear layer and the second linear layer in the multi-frame modality aligner based on a pre-trained single-frame modality aligner.

In some embodiments, the single-frame modality aligner comprises a third linear layer and a fourth linear layer, and wherein the initialization module comprises: a second determining module configured to determine the weight parameters of the first linear layer and the second linear layer based on weight parameters of the third linear layer and the fourth linear layer; and a third determining module configured to determine the bias parameters of the first linear layer and the second linear layer based on bias parameters of the third linear layer and the fourth linear layer.

In some embodiments, the apparatus 700 further comprises: a fourth determining module configured to determine a composition of the plurality of video frames based on a decoding strategy with variable frame rate and a predetermined sampling frame rate, the predetermined sampling frame rate being used to densely sampling frames of the video.

In some embodiments, wherein the fourth determining module comprises: a fifth determining module configured to, in response to detecting an inconsistency between an inference sampling frame rate and the predetermined sampling frame rate, determine the number of repetitions based on the inference sampling frame rate and the predetermined sampling frame rate, the number of repetitions indicating repeated occurrence of a certain frame in the plurality of video frames; and a sixth determining module configured to determine a composition of the plurality of video frames based on the number of repetitions and a certain frame with repeated occurrence.

According to this method, the accuracy of the video content understanding is boosted since the image features generated based on a plurality of frames of the video can capture abundant visual information of the video content. Next, the multi-frame modality aligner generates the visual token according to the generated image features, wherein the visual token integrates dynamic multi-frame information, to reduce the computation complexity of the subsequent language model while providing abundant visual information. Afterwards, the language model implements the understanding for the visual content of the video based on the generated visual token information. This method, combined with advantages of cross-modality fusion, enhances accuracy and comprehensiveness of the video content understanding in all aspects and further improves the user experience.

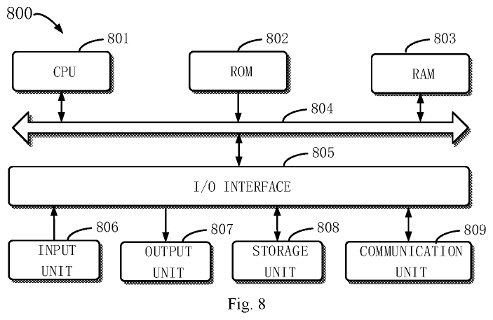

FIG. 8 illustrates a block diagram of a device 800 capable of implementing a plurality of embodiments of the present disclosure. As shown in FIG. 8, the device 800 comprises a central process unit (CPU) and/or graphic processing unit (GPU) 801, which can execute various suitable actions and processing based on the computer program instructions stored in the read-only memory (ROM) 802 or computer program instructions loaded in the random-access memory (RAM) 803 from the storage unit 808. The RAM 803 can also store all kinds of programs and data required by the operation of the device 800. CPU/GPU 801, ROM 802 and RAM 803 are connected to each other via a bus 804. The input/output (I/O) interface 805 is also connected to the bus 804. Although not illustrated in FIG. 8, the device 800 also may comprise a coprocessor.

A plurality of components in the device 800 is connected to the I/O interface 805, comprising: an input unit 806, such as keyboard, mouse and the like; an output unit 807, e.g., various kinds of display and loudspeakers etc.; a storage unit 808, such as disk and optical disk etc.; and a communication unit 809, such as network card, modem, wireless transceiver and the like. The communication unit 809 allows the device 800 to exchange information/data with other devices via the computer network, such as Internet, and/or various telecommunication networks.

The above described respective methods can be executed by the GPU/CPU 801. For example, in some embodiments, the method can be implemented as a computer software program tangibly included in the machine-readable medium, e.g., storage unit 808. In some embodiments, the computer program can be partially or fully loaded and/or mounted to the apparatus 800 via ROM 802 and/or communication unit 809. When the computer program is loaded to RAM 803 and executed by the CPU/GPU 801, one or more steps or actions of the above described method or procedure may be executed.

In some embodiments, the above described method and procedure may be implemented as a computer program product. The computer program product can comprise a computer-readable storage medium, on which the computer-readable program instructions for executing various aspects of the present disclosure are loaded.

The computer-readable storage medium can be a tangible apparatus that maintains and stores instructions utilized by the instruction executing apparatuses. The computer-readable storage medium can be, but not limited to, such as electrical storage device, magnetic storage device, optical storage device, electromagnetic storage device, semiconductor storage device or any appropriate combinations of the above. More concrete examples of the computer-readable storage medium (non-exhaustive list) comprise: portable computer disk, hard disk, random-access memory (RAM), read-only memory (ROM), erasable programmable read-only memory (EPROM or flash), static random-access memory (SRAM), portable compact disk read-only memory (CD-ROM), digital versatile disk (DVD), memory stick, floppy disk, mechanical coding devices, punched card stored with instructions thereon, or a projection in a slot, and any appropriate combinations of the above. The computer-readable storage medium utilized here is not interpreted as transient signals per se, such as radio waves or freely propagated electromagnetic waves, electromagnetic waves propagated via waveguide or other transmission media (such as optical pulses via fiber-optic cables), or electric signals propagated via electric wires.

The described computer-readable program instruction can be downloaded from the computer-readable storage medium to each computing/processing device, or to an external computer or external storage via Internet, local area network, wide area network and/or wireless network. The network can comprise copper-transmitted cable, optical fiber transmission, wireless transmission, router, firewall, switch, network gate computer and/or edge server. The network adapter card or network interface in each computing/processing device receives computer-readable program instructions from the network and forwards the computer-readable program instructions for storage in the computer-readable storage medium of each computing/processing device.

The computer program instructions for executing operations of the present disclosure can be assembly instructions, instructions of instruction set architecture (ISA), machine instructions, machine-related instructions, microcodes, firmware instructions, state setting data, or source codes or target codes written in any combinations of one or more programming languages, wherein the programming languages comprise object-oriented programming languages and traditional procedural programming languages. The computer-readable program instructions can be implemented fully on the user computer, partially on the user computer, as an independent software package, partially on the user computer and partially on the remote computer, or completely on the remote computer or server. In the case where remote computer is involved, the remote computer can be connected to the user computer via any type of networks, comprising local area network (LAN) and wide area network (WAN), or to the external computer (e.g., connected via Internet using the Internet service provider). In some embodiments, state information of the computer-readable program instructions is used to customize an electronic circuit, e.g., programmable logic circuit, field programmable gate array (FPGA) or programmable logic array (PLA). The electronic circuit can execute computer-readable program instructions to implement various aspects of the present disclosure.

The computer-readable program instructions can be provided to the processing unit of general-purpose computer, dedicated computer or other programmable data processing apparatuses to manufacture a machine, such that the instructions that, when executed by the processing unit of the computer or other programmable data processing apparatuses, generate an apparatus for implementing functions/actions stipulated in one or more blocks in the flow chart and/or block diagram. The computer-readable program instructions can also be stored in the computer-readable storage medium and cause the computer, programmable data processing apparatus and/or other devices to work in a particular manner, such that the computer-readable medium stored with instructions comprises an article of manufacture, comprising instructions for implementing various aspects of the functions/actions stipulated in one or more blocks of the flow chart and/or block diagram.

The computer-readable program instructions can also be loaded into computer, other programmable data processing apparatuses or other devices, so as to execute a series of operation steps on the computer, other programmable data processing apparatuses or other devices to generate a computer-implemented procedure. Therefore, the instructions executed on the computer, other programmable data processing apparatuses or other devices implement functions/actions stipulated in one or more blocks of the flow chart and/or block diagram.

The flow chart and block diagram in the drawings illustrate system architecture, functions and operations that may be implemented by device, method and computer program product according to multiple implementations of the present disclosure. In this regard, each block in the flow chart or block diagram can represent a module, a part of program segment or code, wherein the module and the part of program segment or code comprise one or more executable instructions for performing stipulated logic functions. In some alternative implementations, it should be noted that the functions indicated in the block can also take place in an order different from the one indicated in the drawings. For example, two successive blocks can be in fact executed in parallel or sometimes in a reverse order dependent on the involved functions. It should also be noted that each block in the block diagram and/or flow chart and combinations of the blocks in the block diagram and/or flow chart can be implemented by a hardware-based system exclusive for executing stipulated functions or actions, or by a combination of dedicated hardware and computer instructions.

Various embodiments of the present disclosure have been described above and the above description is only exemplary rather than exhaustive and is not limited to the embodiments of the present disclosure. Many modifications and alterations, without deviating from the scope and spirit of the explained various embodiments, are obvious for those skilled in the art. The selection for terms in the text aims to best explain principles and actual applications of each embodiment and technical improvements made in the market by each embodiment, or enable those ordinary skilled in the art to understand embodiments of the present disclosure. cm I/We claim:

1. A method for video understanding, comprising:
generating, by an image encoder, a plurality of image features based on a plurality of frames of a video;
generating, by a multi-frame modality aligner, a visual token based on the plurality of image features, the visual token comprising a dynamic feature among the plurality of frames; and
generating, by a language model, an understanding for the video based on the visual token.

2. The method of claim 1, wherein generating, by the multi-frame modality aligner, the visual token based on the plurality of image features comprises:
generating a concatenated image feature based on the plurality of image features; and
generating, by the multi-frame modality aligner, the visual token based on the generated concatenated image feature.

3. The method of claim 2, wherein the multi-frame modality aligner comprises a first linear layer and a second linear layer, and generating, by the multi-frame modality aligner, the visual token based on the generated concatenated image feature comprises:
mapping, by the first linear layer, the concatenated image feature to a first dimension based on a bias parameter and a weight parameter of the first linear layer; and
mapping, by the second linear layer, the concatenated image feature mapped to the first dimension to a second dimension based on a bias parameter and a weight parameter of the second linear layer, the second dimension corresponding to an input dimension of the language model; and
generating the visual token based on the concatenated image feature that is mapped to the second dimension.

4. The method of claim 3, wherein generating the visual token based on the concatenated image feature that is mapped to the second dimension comprises:
adjusting a dimension size of the concatenated image feature that is mapped to the second dimension; and
executing a feature pooling operation on the concatenated image feature that is mapped to the second dimension with the adjusted dimension size, to generate the visual token whose number has been adjusted.

5. The method of claim 4, wherein generating, by a language model, the understanding for the video based on the visual token comprises:
generating, by the language model, the understanding for the video based on the visual token whose number has been adjusted and a prompt.

6. The method of claim 5, further comprising:
training a visual understanding model, the visual understanding model comprising the image encoder, the multi-frame modality aligner, and the language model.

7. The method of claim 6, wherein training the visual understanding model comprises:
determining a loss of the visual understanding model based on an output of the language model; and
adjusting the language model and the multi-frame modality aligner through back propagation based on the loss.

8. The method of claim 7, wherein the understanding generated by the language model is a label, and adjusting the multi-frame modality aligner through back propagation based on the loss comprises:
adjusting the weight parameters and the bias parameters of the first linear layer and the second linear layer based on the label of the understanding generated by the language model and a label of the video.

9. The method of claim 8, further comprising:
initializing the weight parameters and the bias parameters of the first linear layer and the second linear layer in the multi-frame modality aligner based on a pre-trained single-frame modality aligner.

10. The method of claim 9, wherein the single-frame modality aligner comprises a third linear layer and a fourth linear layer, and initializing the weight parameters and the bias parameters of the first linear layer and the second linear layer in the multi-frame modality aligner based on the pre-trained single-frame modality aligner comprises:
determining the weight parameters of the first linear layer and the second linear layer based on weight parameters of the third linear layer and the fourth linear layer; and
determining the bias parameters of the first linear layer and the second linear layer based on bias parameters of the third linear layer and the fourth linear layer.

11. The method of claim 1, further comprising:
determining a composition of the plurality of video frames based on a decoding strategy with variable frame rate and a predetermined sampling frame rate, the predetermined sampling frame rate being used to densely sampling frames of the video.

12. The method of claim 11, wherein determining the composition of the plurality of video frames based on the decoding strategy with variable frame rate and the predetermined sampling frame rate comprises:
in response to detecting an inconsistency between an inference sampling frame rate and the predetermined sampling frame rate, determining a number of repetitions based on the inference sampling frame rate and the predetermined sampling frame rate, the number of repetitions indicating repeated occurrence of a certain frame in the plurality of video frames; and
determining the composition of the plurality of video frames based on the number of repetitions and the certain frame with repeated occurrence.

13. An electronic device, comprising:
a processor; and
a memory coupled to the processor, the memory having instructions stored therein, the instructions, when executed by the processor, causing the electronic device to:
generate, by an image encoder, a plurality of image features based on a plurality of frames of a video;
generate, by a multi-frame modality aligner, a visual token based on the plurality of image features, the visual token comprising a dynamic feature among the plurality of frames; and
generate, by a language model, an understanding for the video based on the visual token.

14. The electronic device of claim 13, wherein the instructions causing the processor to generate, by the multi-frame modality aligner, the visual token based on the plurality of image features comprise instructions causing the processor to:
generate a concatenated image feature based on the plurality of image features; and
generate, by the multi-frame modality aligner, the visual token based on the generated concatenated image feature.

15. The electronic device of claim 14, wherein the multi-frame modality aligner comprises a first linear layer and a second linear layer, and the instructions causing the processor to generate, by the multi-frame modality aligner, the visual token based on the generated concatenated image feature comprise instructions causing the processor to:
map, by the first linear layer, the concatenated image feature to a first dimension based on a bias parameter and a weight parameter of the first linear layer; and
map, by the second linear layer, the concatenated image feature mapped to the first dimension to a second dimension based on a bias parameter and a weight parameter of the second linear layer, the second dimension corresponding to an input dimension of the language model; and
generate the visual token based on the concatenated image feature that is mapped to the second dimension.

16. The electronic device of claim 15, wherein the instructions causing the processor to generate the visual token based on the concatenated image feature that is mapped to the second dimension comprise instructions causing the processor to:
adjust a dimension size of the concatenated image feature that is mapped to the second dimension; and
execute a feature pooling operation on the concatenated image feature that is mapped to the second dimension with the adjusted dimension size, to generate the visual token whose number has been adjusted.

17. The electronic device of claim 16, wherein the instructions causing the processor to generate, by a language model, the understanding for the video based on the visual token comprises instructions causing the processor to:
generate, by the language model, the understanding for the video based on the visual token whose number has been adjusted and a prompt.

18. The electronic device of claim 17, further comprising instructions causing the processor to:
train a visual understanding model, the visual understanding model comprising the image encoder, the multi-frame modality aligner, and the language model.

19. The electronic device of claim 18, wherein the instructions causing the processor to train the visual understanding model comprise instructions causing the processor to:
determine a loss of the visual understanding model based on an output of the language model; and
adjust the language model and the multi-frame modality aligner through back propagation based on the loss.

20. A non-transitory computer-readable medium comprising instructions stored thereon which, when executed by a processor, cause the processor to:
generate, by an image encoder, a plurality of image features based on a plurality of frames of a video;
generate, by a multi-frame modality aligner, a visual token based on the plurality of image features, the visual token comprising a dynamic feature among the plurality of frames; and
generate, by a language model, an understanding for the video based on the visual token.
